(19) United States
(12) Patent Application Publication
(10) Pub. No.: US 2007/0198640 A1
(43) Pub. Date: Aug. 23, 2007

(54) Mail processing server, mail processing method, and mail processing program

(75) Inventors: Nobuo Kawakami, Tokyo (JP); Makoto Nakano, Tokyo (JP)

Correspondence Address: GREENBLUM & BERNSTEIN, P.L.C., 1950 ROLAND CLARKE PLACE, RESTON, VA, 20191, US

(73) Assignee: Dwango Co., Ltd., Tokyo (JP)

(21) Appl. No.: 11/239,089

(22) Filed: Sep. 30, 2005

(30) Foreign Application Priority Data
Aug. 5, 2005 (JP) 2005-228132
Sep. 27, 2005 (JP) 2005-280973

(51) Int. Cl. G06F 15/16

(52) U.S. Cl. 709/206

(57) ABSTRACT

It is intended to provide a mail service capable of maintaining user's anonymousness and preserving convenience of mail function. This invention enables connecting a forwarding mail address to be used for receiving mails with at least a mail address of a user and a forwarding criteria in generating the forwarding mail address; storing the user's mail address and the forwarding criteria as forwarding mail address information; confirming, in the case of receiving a mail sent to the forwarding mail address, the user's mail address to which the mail is to be forwarded and the forwarding criteria by referring to the forwarding mail address information to judge whether or not it is possible to forward the mail to the user's mail address; and forwarding the mail to the user's mail address in the case where it is judged that the mail can be forwarded.

The present invention relates to subject matter contained in Japanese Patent Application No. 2005-228132, filed on Aug. 5, 2005, and Japanese Patent Application No. 2005-280973, filed on Sep. 27, 2005, the disclosures of which are expressly incorporated herein by reference in their entirety.

### BACKGROUND OF THE INVENTION

1. Field of the Invention

This invention relates to a mail processing server, a mail processing method, and a mail processing program to be used for forwarding a received mail to a mail address of a user.

2. Description of the Related Art

In recent years, a mail function has become one of indispensable functions of a mobile phone. From statistics on mobile phone usage, it is revealed that use of mail function is predominantly frequent than use of phone function. People use the mail function carefreely since a mail fee is usually lower than a telephone fee, and such carefree use is the primary reason for the popularity.

Other reasons may be that: the mail function does not limit time and place of the usage and makes it possible to do mindless chatter at anytime and anywhere; the user does not have to deal with a mail when the user is not interested in contents of the mail or it is unnecessary for the user to respond to the mail; and inconvenience that can be caused to a user at the other end is reduced due to less immediacy and readiness as compared to the telephone function and does not impinge on space and time of the users in real time.

The message exchange via the mobile terminal is not limited to that with a specified person, and, since it is possible to perform the message exchange with unspecified majority, it is necessary to recognize manner and common sense in using the mail function for the message exchanges.

Currently available services using the mail function bear a problem of unsolicited mail which is a mail sent due to a leakage of mail address to an unspecified third, party. One of countermeasures against the unsolicited mail is a setting of mail rejection to the unsolicited mail.

However, the method of setting mail rejection to unsolicited mail is troublesome because it is necessary to set the mail rejection to each of unsolicited mails. Japanese published Unexamined Patent Application No. 2003-196216 is an example of the related Art.

The above mentioned Patent Literature proposes a mail address processing system method as the countermeasure against unsolicited mails, wherein: a variable part is provided in a user name in a mail address so that a value of the variable part is changed depending on mail receivers to control a state of communicated mail addresses; and an accidental mail address leakage is prevented by changing the value of the variable part to a value which is difficult to guess.

The method disclosed in the above-mentioned Patent Literature is considered to be effective in preventing the accidental mail address leakage by using the hard-to-guess value as the value of the variable part included in the mail address; however, the method has a problem of the troublesome operation of changing the value of the variable part from mail receiver to mail receiver.

Furthermore, unsolicited mails are usually generated by software which automatically creates mail addresses at random to be sent, and, even if a hard-to-guess value is used as the value of the variable part, it is necessary to change again the value of the variable part from mail receiver to mail receiver once the mail address is created by the software, thereby making the method still troublesome.

Also, even if a hard-to-guess value is used as the value of the variable part, it is difficult to maintain anonymousness of a sender because of reasons such as accidental leakage of sender's mail address. Therefore, in the case where the user wishes to readily interact with unspecified number of people, the easiness of mail function is undesirably impaired in view of abuse of mail addresses and the like.

Development of a mail processing server which is capable of providing a mail service which maintains user's anonymousness and ensures the convenience of mail function in order to solve the above problems has been in demand.

### SUMMARY OF THE INVENTION

This invention has been accomplished in view of the above-described circumstances, and an object thereof is to provide a mail processing server, a mail processing method, and a mail processing program capable of setting a mail address different from an original address (address usable under the contract with a mobile phone service provider) and forwarding to the original address only a mail matching a criteria desired by a user among mails sent to the mail address.

According to one aspect of this invention there is provided a mail processing server forwarding a received mail to a mail address of a user, the mail processing server comprising: a forwarding mail address generation unit for connecting a forwarding mail address to be used for receiving mails with at least the user's mail address and a forwarding criteria in generating the forwarding mail address; a forwarding mail address information storage for storing, as forwarding mail address information, the forwarding mail address generated by the forwarding mail address generation unit after connecting the forwarding mail address with at least the user's mail address and the forwarding criteria; a received mail storage for receiving and storing mails sent to the forwarding mail address generated by the forwarding mail address generation unit; a mail processing server 20 for reading the mail stored in the received mail storage, referring to the forwarding mail address information stored in the forwarding mail address information storage, confirming the user's mail address to which the mail is to be forwarded and the forwarding criteria, and judging whether or not it is possible to forward the mail to the mail address stored in the forwarding mail address information; and a mail forwarding unit for forwarding, in the case where the mail processing server 20 judges that the forwarding is possible, the mail stored by the received mail storage to the user's mail address stored in the forwarding mail address information.

The forwarding mail address generation unit may set the forwarding criteria upon reception of a forwarding criteria setting request from the user.

The forwarding criteria may be a time period during which it is possible to forward to the user's mail address the mail sent to the forwarding mail address.

The forwarding criteria may be information for specifying a sender who can send a mail to the forwarding mail address.

The forwarding criteria may be a frequency of the mail forwarding to the forwarding mail address.

The mail processing server 20 may forward the mail stored by said received mail storage after replacing a sender's mail address into a forwarding mail address created by the sender.

According to another aspect of this invention, there is provided a mail processing method to be used in a server forwarding a received mail to a user's mail address, the mail processing method comprising: connecting a forwarding mail address to be used for receiving mails with at least the user's mail address and a forwarding criteria in generating the forwarding mail address; storing the forwarding mail address generated as forwarding mail address information in database connected to the server after connecting the forwarding mail address with at least the user's mail address and the forwarding criteria; receiving mails sent to the forwarding mail address and storing the mails in a memory provided in the server; reading the mail stored in the memory, referring to the forwarding mail address information stored in the database, confirming the user's mail address to which the mail is to be forwarded and the forwarding criteria, and judging whether or not it is possible to forward the mail to the mail address stored in the forwarding mail address information; and forwarding the mail stored in the memory to the user's mail address stored in the database in the case where it is judged that the mail forwarding is possible.

The forwarding criteria may be set upon reception of a forwarding criteria setting request from the user.

The forwarding criteria may be a time period during which it is possible to forward to the user's mail address the mail sent to the forwarding mail address.

The forwarding criteria may be information for specifying a sender who can send a mail to the forwarding mail address.

The forwarding criteria may be a frequency of the mail forward to the forwarding mail address.

The mail stored by said received mail storage may be forwarded after a sender's mail address of the mail is replaced by a forwarding mail address created by the sender.

According to still another aspect of this invention, there is provided a mail processing program to be used in a server forwarding a received mail to a user's mail address, the mail processing program comprising: connecting a forwarding mail address to be used for receiving mails with at least the user's mail address and a forwarding criteria in generating the forwarding mail address; storing the forwarding mail address generated as forwarding mail address information in database connected to the server after connecting the forwarding mail address with at least the user's mail address and the forwarding criteria; receiving mails sent to the forwarding mail address and storing the mails in a memory provided in the server; reading the mail stored in the memory, referring to the forwarding mail address information stored in the database, confirming the user's mail address to which the mail is to be forwarded and the forwarding criteria, and judging whether or not it is possible to forward the mail to the mail address stored in the forwarding mail address information; and forwarding the mail stored in the memory to the user's mail address stored in the database in the case where it is judged that the mail forward is possible.

The forwarding criteria may be set upon reception of a forwarding criteria setting request from the user.

The forwarding criteria may be a time period during which it is possible to forward to the user's mail address the mail sent to the forwarding mail address.

The forwarding criteria may be information for specifying a sender who can send a mail to the forwarding mail address.

The forwarding criteria may be a frequency of the mail forward to the forwarding mail address.

The mail stored by said received mail storage may be forwarded after a sender's mail address of the mail is replaced by a forwarding mail address created by the sender.

The mail processing server, the mail processing method, and the mail processing program of this invention enables: connecting a forwarding mail address to be used for receiving mails with at least a mail address of a user and a forwarding criteria in generating the forwarding mail address; storing the user's mail address and the forwarding criteria as forwarding mail address information; confirming, in the case of receiving a mail sent to the forwarding mail address, the user's mail address to which the mail is to be forwarded and the forwarding criteria by referring to the forwarding mail address information to judge whether or not it is possible to forward the mail to the user's mail address; and forwarding the mail to the user's mail address in the case where it is judged that the mail can be forwarded.

Thus, it is possible for the user to set the mail address different from the original address (address usable under the contract with a mobile phone service provider) and to forward to the original address only a mail matching the criteria desired by the user among mails sent to the mail address, and, therefore, the user can enjoy the mail service which maintains anonymousness of the sender and preserves convenience of the mail function.

The above as well as additional objects, features, and advantages of the present invention will become apparent in the following detailed written description.

### BRIEF DESCRIPTION OF THE DRAWINGS

FIG. 1 is a diagram showing one example of embodiment of a system including a mail processing server of this invention.

FIG. 2 is a block diagram showing details of the mail processing server of FIG. 1.

FIG. 3 is an illustration of details of tables stored in data base of FIG. 1.

FIG. 4 is a flowchart of a user registration by the mail processing server of FIG. 1.

FIG. 5 is an illustration of the user registration by the mail processing server of FIG. 1.

FIG. 6 is a flowchart of temporary mail address creating processing in the mail processing server of FIG. 1.

FIG. 7 is an illustration of the temporary mail address creating processing in the mail processing server of FIG. 1.

FIG. 8 is a flowchart of forward processing of mail sent to the temporary mail address created in the mail processing server of FIG. 1.

FIG. 9 is a flowchart of an application example of the forward processing of mail sent to the temporary mail address created in the mail processing server of FIG. 1.

FIG. 10 is a flowchart of the address replacement processing shown as Step S906 in FIG. 9.

### DESCRIPTION OF THE EMBODIMENTS

In embodiments of this invention described below, a mail processing server enables a user who has performed a user registration to create a forwarding mail address for which a forwarding criteria is set and forwards a mail sent to the forwarding mail address after judging whether or not the mail matches the forwarding criteria to a mail address of the user.

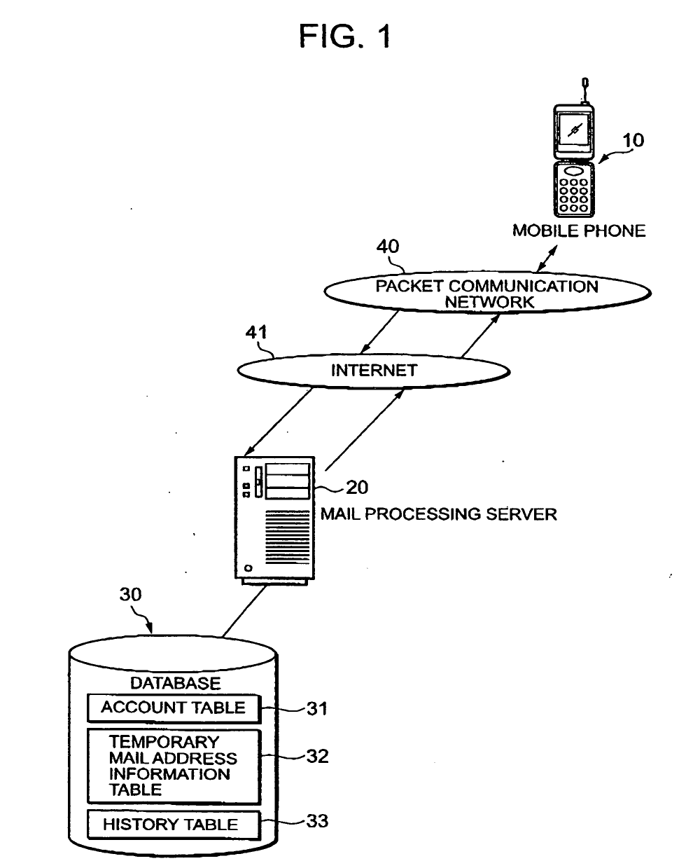

FIG. 1 is a diagram showing one embodiment of a system including the mail processing server of this invention. In this embodiment, the forwarding mail address is referred to as “temporary mail address” and the user's mail address which is used under the contract with a communication carrier (provider of communication service) of the mobile phone is referred to as “original address”.

The system shown in FIG. 1 is provided with a mobile phone 10, a mail processing server 20, and a database 30. The mobile phone 10 is a terminal device capable of sending/receiving mails by communicating with the mail processing server 20 via a packet communication network 40 of communication carriers and the internet 41 serving a communication line. Though the mobile phone 10 is used in this embodiment, the terminal device is not limited to the mobile phone 10, and it is possible to use terminal devices capable of sending/receiving mails, such as a personal computer and a PDA.

The mail processing server 20 is controlled by a provider of the service of the temporary mail address utilization for forwarding mails to the original mail address depending on the forwarding criteria.

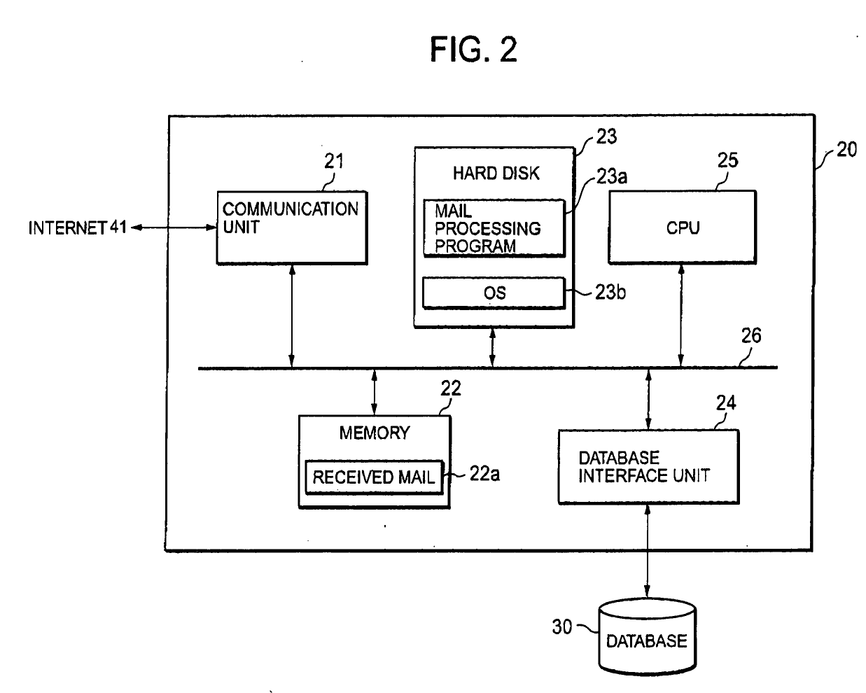

FIG. 2 is a block diagram showing details of the mail processing server 20. The mail server 20 has a communication unit 21, a memory 22, a hard disk 23, a database interface unit 24, and a CPU 25.

The communication unit 21 performs a packet communication with the mobile phone 10 via the internet 41 to receive data of a received mail 22a. The memory 22 serving as a received mail storage stores the mail 22a received from the mobile phone 10. The storage of the received mail 22a may be temporary or the data of the received mail 22a may be forwarded to the hard disk 23 from the memory 22 to be stored in the hard disk 23 for a certain period of time.

The hard disk 23 stores a mail processing program 23a of this invention and an OS (Operating System) 23b. The data interface unit 24 is connected to the database 30 to communicate data with the database. The CPU 25 controls the above-described hardwares. The hardwares are connected to one another by a bus 26.

A mail processing function is realized by the mail processing program 23a read out from the hard disk 23 under the control of the CPU 25 and generate the temporary mail address, judge whether or not it is possible to forward to the original address a mail sent to the temporary mail address, and forward the mail in the case where it is judged that the mail forward is acceptable.

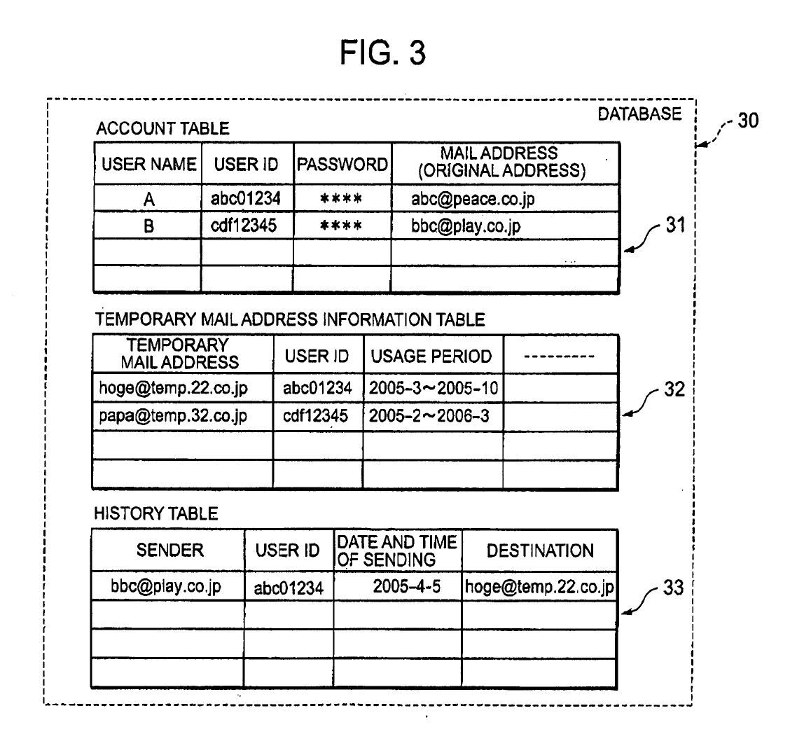

Referring back to FIG. 1, the database 30 serving as forwarding mail address information storage stores an account table 31, a temporary mail address information table 32, and a history table 33. The tables will be described below using FIG. 3.

FIG. 3 is an illustration of details of tables stored in the database 30. The account table 31 stores information of user who performed user registration, and at least a user name, a user ID, a password, and a mail address (original address) are registered in the account table 31.

As the user ID, a unique user ID stored in the mobile phone 10 and informed to the mail processing server 20 when the mobile terminal 10 accesses to the server is registered without limitation thereto. The user ID may be given by the mail processing server.

The temporary mail address generated by the above-described forwarding mail generation, the above-described user ID, a usage period which is an item of the forwarding criteria set by the user, and the like are registered on the temporary mail address information table 32 corresponding to the forwarding criteria set by the user.

The usage period is one example of the forwarding criteria, and other various items such as a designation of a sender who can send mails to the temporary mail address (ex. designation of sender's mail address), a designation of frequency of mail forwarding using the temporary mail address, a time of a day for using the temporary mail address, a day of a week, a sex, and a weather may be used as the forwarding criteria. The number of items included in a forwarding criteria is not limited to one, and it is possible to use plural items of the forwarding criteria, such as the usage period and the designation of sender who can send mails.

The account table 31 and the temporary mail address information table 32 are associated with each other by using the user ID as a key, and information stored in the tables 31 and 32 is the forwarding mail address information of this invention. For instance, a case wherein information of users A and B is registered is shown in FIG. 3. In the case where an original address of the user A is “abc@peace.co.jp”, a temporary mail address of the user A “hoge@temp.22.co.jp” is generated to be stored. In the case where an original address of the user B is “bbc@play.co.jp”, a temporary mail address of the user B “papa@temp.32.co.jp” is generated to be stored.

A history of communication of a mail using the generated temporary address is stored in the history table 33, and, for example, a mail address of a sender of the mail and a user ID of a user having a designated temporary mail address, a date and time of sending, and the designated temporary mail address are registered. The history table 33 is used as a reference for judging whether or not a forwarding criteria is satisfied in the case where the forwarding criteria is the frequency of mail forward, for example.

Hereinafter, operation of the mail processing server 20 will be described.

(User Registration)

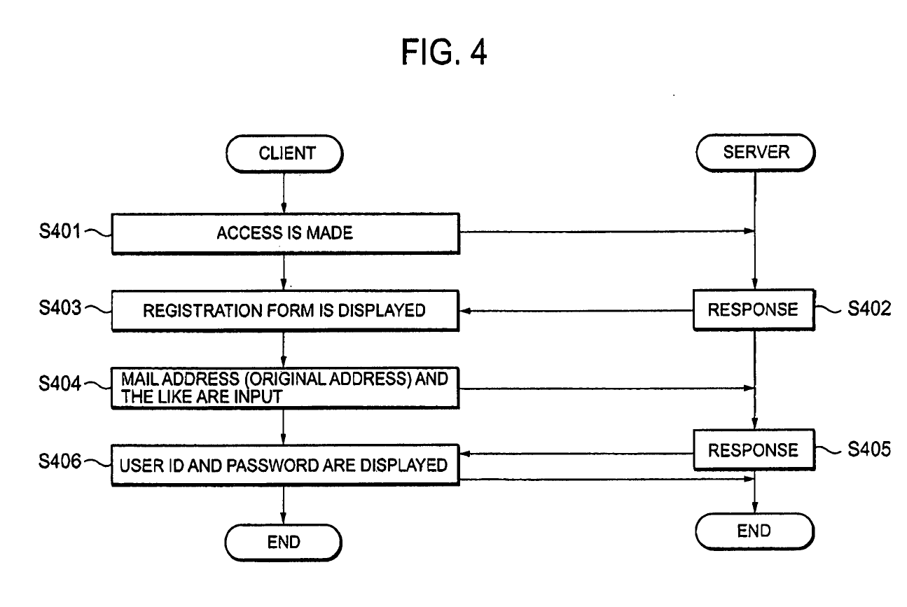

A case wherein a user A performs a user registration will be described using FIG. 4.

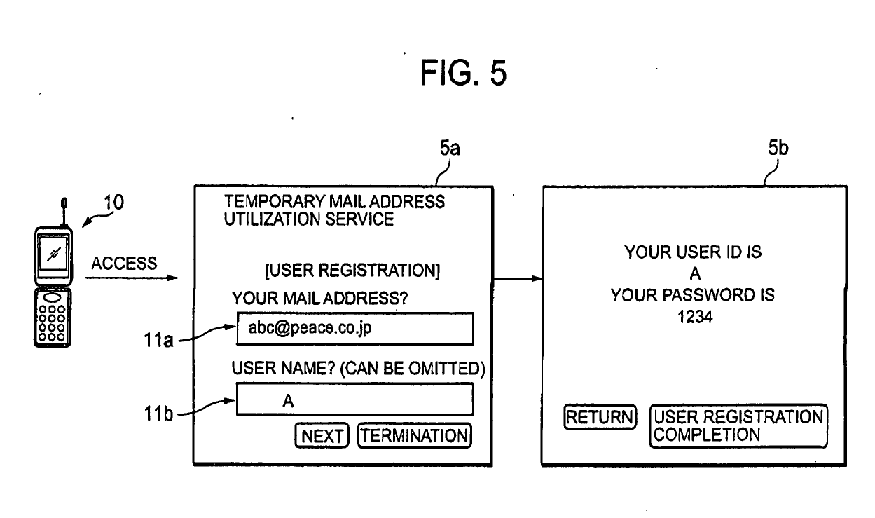

When the mobile phone 10 gains access to the mail processing server 20 (Step S401), the mail server 20 responds to the access (Step S402), so that a predetermined registration form shown in 5a of FIG. 5 is displayed on a screen of the mobile phone 10 (step S403).

The user A inputs the mail address (original mail address) set in the mobile phone 10 in an input column 11a of 5a of FIG. 5 and then inputs a user name (input of user name can be omitted) in an input column 11b (Step S404). When The user A selects “NEXT”, the mail processing server 20 responds (Step S405) so that the input user name and a password as 5b of FIG. 5 are displayed (Step S406). In the case where the user wants to stop the user registration on a screen page 5a of FIG. 5, the user'selects “TERMINATION”.

When the user finds a mistake in the mail address on the screen page 5b of FIG. 5, the user'selects “Return” to return to the screen page 5a of FIG. 5 to input the mail address again. When the user wants to settle the registration on the screen page 5b of FIG. 5, the user'selects “USER REGISTRATION COMPLETION”.

When the user registration is accepted, at least the user name, the user ID, the password, and the mail address (original address) are registered on the account table 31 of the database 30. As described in the foregoing, the user ID is the specific user ID stored in the mobile phone 10 which is informed to the mail processing server 20 when the mobile terminal 10 gains access to the server in this embodiment; however, the user ID is not limited thereto, and the mail processing server 20 may independently give the user ID. Though the password is automatically given by the server in this embodiment, an arbitrary password may be set by the user.

(Temporary Mail Address Creation)

Hereinafter, creation of temporary mail address performed after the user registration will be described. In the following description, a case wherein the user A makes a temporary mail address creation request is described by way of example.

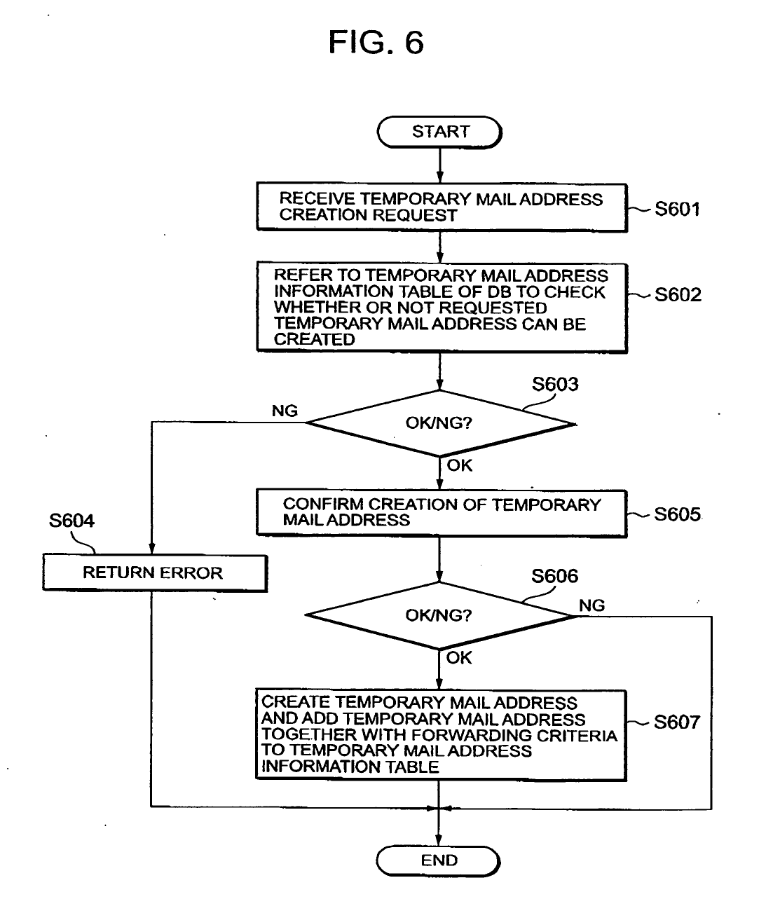

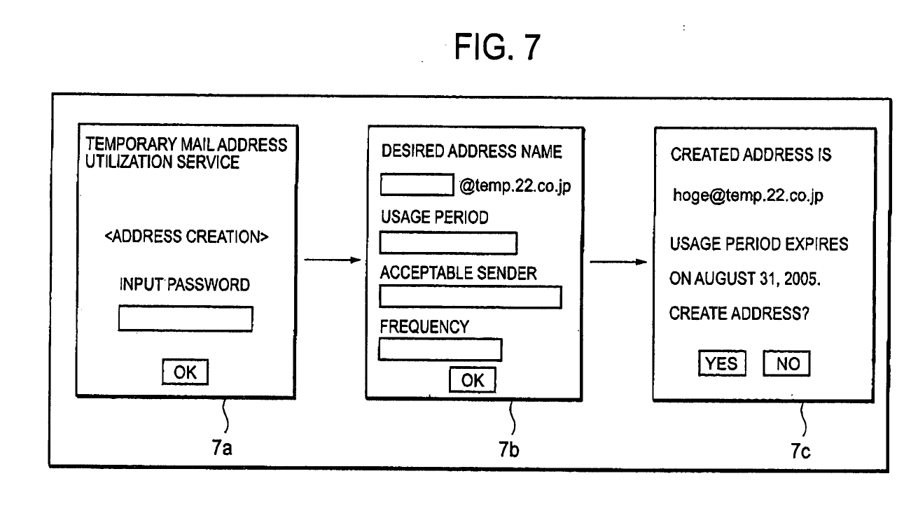

FIG. 6 is a flowchart showing temporary mail address creation processing in the mail processing server 20. The forwarding mail address generation of the mail processing server 20 receives a temporary mail address creation request from the user A using the mobile phone 10 (Step S601). More specifically, upon reception of access from the mobile phone 10, a password input screen shown as 7a in FIG. 7 is displayed. After authorization using the password, a screen page 7b in FIG. 7 is displayed to accept inputs of forwarding criteria such as an address name of the temporary mail address and a usage period from the user A.

The forwarding mail address generation of the mail processing server 20 refers to the temporary mail address information table 32 stored in the database 30 which is the forwarding mail address information storage to check whether or not it is possible to create the temporary mail address requested by the user A, i.e., whether not the temporary mail address has already exist (Step S602).

In the case where it is judged that the requested temporary mail address can not be created (NG in Step S603), an error is returned to the user A in such a manner that a screen page indicating the judgment (step S604) or the like is displayed to terminate the processing. In turn, in the case where it is judged that the requested temporary mail address can be created (OK in Step S603), a screen page 7C of FIG. 7 is displayed to confirm creation of the temporary mail address with the user A (Step S605).

When the user A selects “YES” to agree the temporary mail address creation (OK in Step S606), the forwarding mail address generation of the mail processing server 20 creates the temporary mail address to add the temporary mail address to the temporary mail address information table 32 stored in the database 30 serving as the forwarding mail address information storage together with the set forwarding criteria (Step S607).

The created temporary mail address may exist until the user accesses the mail processing server 20 to delete the temporary mail address or, in the case where a certain period or a usage period has been set, the created temporary mail address may be deleted automatically after the usage period has been passed.

(Mail Send Processing)

Hereinafter, forward processing of a mail sent to the created temporary mail address will be described. In the following description, a case wherein a user B sends a mail to the temporary mail address created by the user A who performed the user registration is described by way of example. The user B does not necessarily perform the user registration.

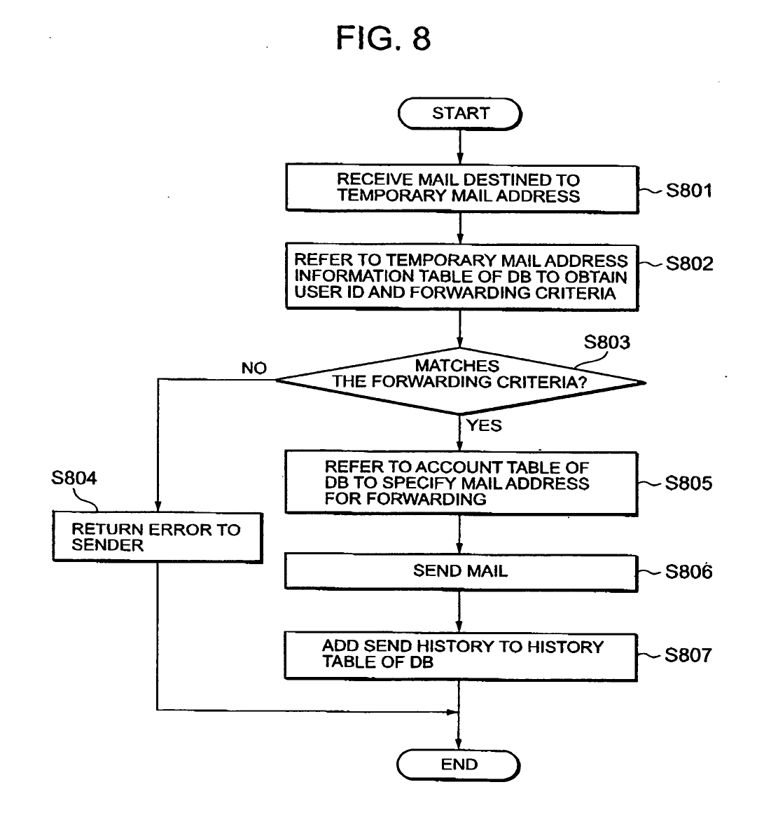

As shown in FIG. 8, the mail sent from the user B to the temporary mail address of the user A is received via the packet communication network 40, the internet 41, and the communication unit 21 of the mail processing server 20 (Step S801). The received mail is temporarily stored in the memory 22 serving as the received mail storage.

Then, the mail processing server 20 refers to the temporary mail address information table 32 stored in the database 30 serving as the forwarding mail address information storage to obtain the user ID and the forwarding criteria of the user A by using the temporary mail address of the user A as a key (Step S802) and to judge whether or not the mail matches the forwarding criteria (Step S803). In the case where it is judged that the mail does not match the forwarding criteria (NO in Step S803), an error is returned to the user B who is the sender in such a manner by sending a mail or the like informing that the mail can not be sent.

In the case where the mail processing server 20 judges that the mail matches the forwarding criteria (YES in Step S803), the mail processing server 20 refers to the account table 31 stored in the database 30 to obtain the original mail address of the user A to whom the mail is forwarded (Step S805). The mail processing server 20 sends the mail to the original address of the user A (Step S806) and then adds the history to the history table 33 stored in the database 30 (step S807) to terminate the processing.

(Application Example of Mail Sending Processing: Conversion of from into Temporary Mail Address)

Hereinafter, an application example of the above-described mail transmission processing will be described. In this application example, each of the user A and B has performed the user registration and created a temporary mail address, so that, when the user B sends a mail to the temporary mail address created by the user A, a sender's address display (hereinafter referred to as from) of the mail sent to the user A is replaced by the temporary mail address of the user B. This processing is performed for the purposes of enabling the user B to exchange mails with the user A without informing an original address and enabling the user A and B to use only the temporary mail addresses in the mail exchanges.

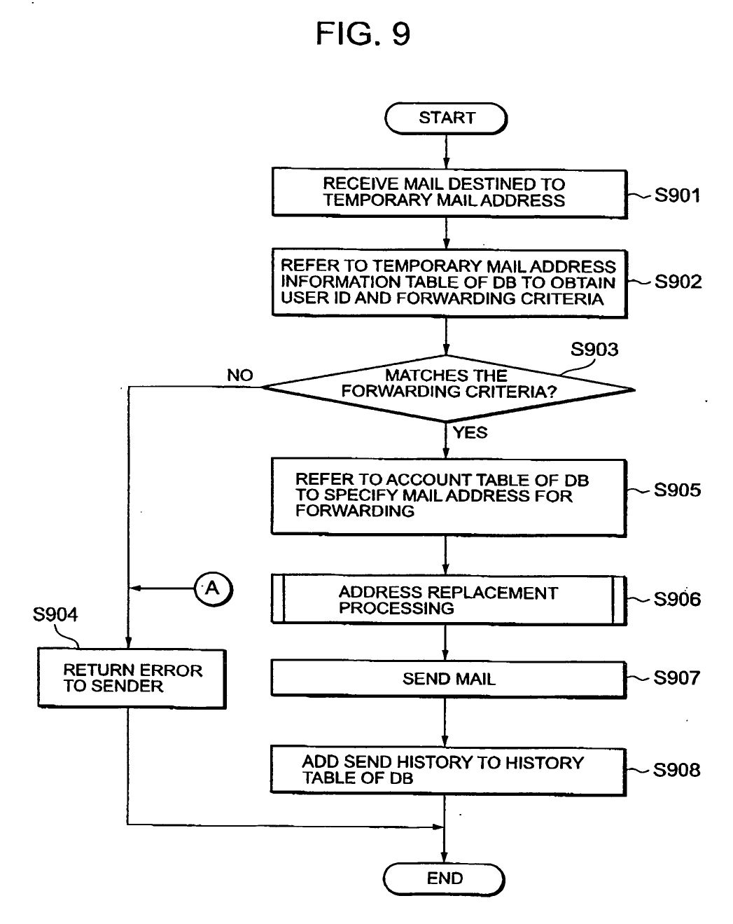

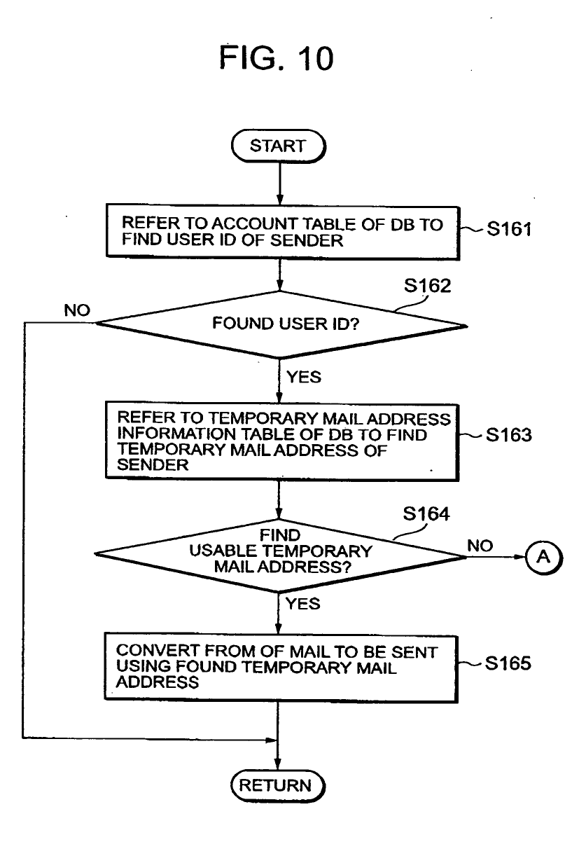

FIG. 9 is a flowchart showing the mail sending processing of the application example. Since the processing except for Step 906 (address replacement step) shown in FIG. 9 is the same as the processing of S801 to S807 shown in FIG. 8 described in the foregoing, the description for the processing is omitted. The address replacement processing of step S906 of FIG. 9 will be described using FIG. 10.

FIG. 10 is a flowchart showing the address replacement processing of S906 of FIG. 9. The mail processing server 20 uses the original address of the user B described as a sender in the mail received from the user B as a key to refer to the account table 31 stored in the database 30 and searches an user ID of the sender, i.e., the user B (Step S161).

In the case where the user ID of the user B is found (YES in Step S162), it is understood that the user B has performed the user registration, and, therefore, the mail the user A unit of the mail processing server 20 refers to the temporary mail address information table 32 stored in the database 30 to search a temporary mail address of the sender, i.e., the user B (Step S163).

Then, the mail processing server 20 judges whether or not a temporary mail address that can be used by the user A is included among temporary mail addresses created by the user B (Step S164). As used herein, the temporary mail address of the user B usable by the user A means that, when the user A sends a mail to the temporary mail address of the user B, the mail is forwarded to the user B without returning of an error as mismatching the forwarding criteria because the user A is included in specified senders of the forwarding criteria or the like.

In the case where it is judged that there is not any usable temporary mail address (NO in Step S164), an error is returned to the user B (Step S904 in FIG. 9), so that a user who has performed user registration does not have to reveal an original address for sending a mail to a temporary mail address of another user. In addition, a temporary mail address of the user B that can be used by the user A may be automatically created by the forwarding mail address generation of the mail processing server 20 without returning the error.

In the case where it is judged that there is the usable temporary mail address (YES in Step S164), the mail processing server 20 replaces the from of the mail sent by the user B using the found temporary mail address (Step S165) to terminate the address replacement processing.

Hereinafter, effects of this embodiment will be described. As described in the foregoing, according to the mail processing server 20 of this invention, the user can set a temporary mail address which is different from an original address, and, among mails sent to the temporary mail address, only a mail matching a forwarding criteria desired by the user is sent to the original address. Therefore, it is possible to provide a mail service which maintains anonymousness of the user and preserves convenience of mail function.

Also, since the user can create ever so many temporary mail addresses each of which has a forwarding criteria according to user's preference, it is possible to use the temporary mail addresses appropriately according to mail receivers, thereby achieving a mail service with enhanced convenience.

In the case where a certain period or a usage period is set for the created temporary mail address, by setting that the temporary mail address to be deleted automatically after the usage period has passed, such temporary mail address is considerably conveniently used for mail exchanges with a person with whom the user has to communicate only temporarily. In this case, because the temporary mail address is automatically deleted, the user is not required to do anything when it has become unnecessary for the user to communicate with the person, thereby achieving a disposable mail address.

When the mail address of a sender is replaced by the temporary mail address by the address replacement processing, it is possible for the sender and the receiver to communicate without revealing original addresses. Therefore, mail service which enables the users to maintain anonymousness and to enjoy the convenience of mail function is provided.

This invention is applicable to general communication systems using a terminal device having a mail function.

What is claimed is:

1. A mail processing server forwarding a received mail to a mail address of a user, comprising:
a forwarding mail address generation unit for connecting a forwarding mail address to be used for receiving mails with at least the user's mail address and a forwarding criteria in generating the forwarding mail address;
a forwarding mail address information storage for storing, as forwarding mail address information, the forwarding mail address generated by said forwarding mail address generation unit after connecting the forwarding mail address with at least said user's mail address and said forwarding criteria;
a received mail storage for receiving and storing mails sent to the forwarding mail address generated by said forwarding mail address generation unit;
a judgment unit for reading the mail stored in said received mail storage, referring to the forwarding mail address information stored in said forwarding mail address information storage, confirming the user's mail address to which the mail is to be forwarded and the forwarding criteria, and judging whether or not it is possible to forward the mail to the mail address stored in said forwarding mail address information; and
a mail forwarding unit for forwarding, in the case where the judgment unit judges that the forwarding is possible, the mail stored by said received mail storage to the user's mail address stored in said forwarding mail address information.

2. The mail processing server according to claim 1, wherein said forwarding mail address generation unit sets the forwarding criteria upon reception of a forwarding criteria setting request from the user.

3. The mail processing server according to claim 1, wherein said forwarding criteria is a time period during which it is possible to forward the user's mail address the mail sent to the forwarding mail address.

4. The mail processing server according to claim 1, wherein said forwarding criteria is information for specifying a sender who can send a mail to the forwarding mail address.

5. The mail processing server according to claim 1, wherein said forwarding criteria is a frequency of the mail forward to the forwarding mail address.

6. The mail processing server according to claim 1, wherein said mail forwarding unit (forwards) the mail stored by said received mail storage after replacing a sender's mail address into a forwarding mail address created by the sender.

7. A mail processing method to be used in a server forwarding a received mail to a user's mail address, comprising:
connecting a forwarding mail address to be used for receiving mails with at least the user's mail address and a forwarding criteria in generating the forwarding mail address;
storing the forwarding mail address generated as forwarding mail address information in a database connected to said server after connecting the forwarding mail address with at least said user's mail address and said forwarding criteria;
receiving mails sent to said forwarding mail address and storing the mails in a memory provided in said server;
reading the mail stored in said memory, referring to the forwarding mail address information stored in said database, confirming the user's mail address to which the mail is to be forwarded and the forwarding criteria, and judging whether or not it is possible to forward the mail to the mail address stored in said forwarding mail address information; and
forwarding the mail stored in said memory to the user's mail address stored in said database in the case where it is judged that the mail forward is possible.

8. The mail processing method according to claim 7, wherein the forwarding criteria is set upon reception of a forwarding criteria setting request from the user.

9. The mail processing method according to claim 7, wherein said forwarding criteria is a time period during which it is possible to forward to the user's mail address the mail sent to the forwarding mail address.

10. The mail processing method according to claim 7, wherein said forwarding criteria is information for specifying a sender who can send a mail to the forwarding mail address.

11. The mail processing method according to claim 7, wherein said forwarding criteria is a frequency of the mail forward to the forwarding mail address.

12. The mail processing method according to claim 7, wherein the mail stored by said received mail storage is forwarded after a sender's mail address of the mail is replaced by a forwarding mail address created by the sender.

13. A mail processing program to be used in a server forwarding a received mail to a user's mail address, comprising:
connecting a forwarding mail address to be used for receiving mails with at least the user's mail address and a forwarding criteria in generating the forwarding mail address;
storing the forwarding mail address generated as forwarding mail address information in a database connected to said server after connecting the forwarding mail address with at least said user's mail address and said forwarding criteria;
receiving mails sent to said forwarding mail address and storing the mails in a memory provided in said server;
reading the mail stored in said memory, referring to the forwarding mail address information stored in said database, confirming the user's mail address to which the mail is to be forwarded and the forwarding criteria, and judging whether or not it is possible to forward the mail to the mail address stored in said forwarding mail address information; and
forwarding the mail stored in said database to the user's mail address stored in said memory in the case where it is judged that the mail forward is possible.

14. The mail processing program according to claim 13, wherein the forwarding criteria is set upon reception of a forwarding criteria setting request from the user.

15. The mail processing program according to claim 13, wherein said forwarding criteria is a time period during which it is possible to forward to the user's mail address the mail sent to the forwarding mail address.

16. The mail processing program according to claim 13, wherein said forwarding criteria is information for specifying a sender who can send a mail to the forwarding mail address.

17. The mail processing program according to claim 13, wherein said forwarding criteria is a frequency of the mail forward to the forwarding mail address.

18. The mail processing program according to claim 13, wherein the mail stored by said received mail storage is forwarded after a sender's mail address of the mail is replaced by a forwarding mail address created by the sender.
